(19) United States
(12) Patent Application Publication
(10) Pub. No.: US 2008/0270760 A1
(43) Pub. Date: Oct. 30, 2008

(54) DEBUG SUPPORT METHOD AND APPARATUS

(75) Inventor: Yuichi ODA, Kawasaki-shi (JP)

Correspondence Address: OBLON, SPIVAK, MCCLELLAND MAIER & NEUSTADT, P.C., 1940 DUKE STREET, ALEXANDRIA, VA, 22314, US

(73) Assignee: KABUSHIKI KAISHA TOSHIBA, Tokyo (JP)

(21) Appl. No.: 12/051,581

(22) Filed: Mar. 19, 2008

(30) Foreign Application Priority Data
Apr. 25, 2007 (JP) 2007-115263

(51) Int. Cl. G06F 9/30

(52) U.S. Cl. 712/208; 712/E09.028

(57) ABSTRACT

According to the present invention, there is provided a debug support apparatus having, a decoder configured to receive an instruction output from a compiler which receives a source code, decode the instruction, and output a decoding result; and a display unit configured to receive debug information output from the compiler and the decoding result output from the decoder and display at least a correspondence between each decoded instruction and a position in the source code.

### CROSS REFERENCE TO RELATED APPLICATION

This application is based upon and claims benefit of priority under 35 USC §119 from the Japanese Patent Application No. 2007-115263, filed on Apr. 25, 2007, the entire contents of which are incorporated herein by reference.

### BACKGROUND OF THE INVENTION

The present invention relates to a debug support method and apparatus.

VLIW is a technique for speeding up programs by simultaneously executing an instruction set made up of a plurality of independent instructions. Loop unrolling and software pipelining are available as techniques for greatly enhancing the VLIW effects.

A conventional debug support apparatus for a source program complied by a compiler which employs the above techniques suffers the following problems.

1) Each instruction included in one instruction group cannot be displayed in correspondence with the corresponding line number on a source code. This makes it impossible to make accurate correspondence between each instruction and the corresponding line number, thereby degrading debug efficiency.

2) It is impossible to display which processor of a multiprocessor has executed each instruction included in one instruction group or which slot of a processor having a plurality of slots is used to execute such an instruction. Therefore, the correspondence between each instruction and each processor or slot is unclear, thereby degrading debug efficiency.

3) No mechanism is available to analyze iteration information. It is, therefore, impossible to display the correspondence between the iteration and each instruction included in an instruction group, thereby degrading debug efficiency.

The debug efficiency of the conventional debug support apparatus inevitably degrades due to the above problems. A reference which discloses the conventional debug technique is as follows:

Japanese Patent Laid-Open No. 2003-140920

### SUMMARY OF THE INVENTION

According to one of the aspects of the present invention, there is provided a debug support apparatus comprising, a decoder configured to receive an instruction output from a compiler which receives a source code, decode the instruction, and output a decoding result, and a display unit configured to receive debug information output from the compiler and the decoding result output from the decoder and display at least a correspondence between each decoded instruction and a position in the source code.

According to one of the aspects of the present invention, there is provided a method of performing debug support using a debug support apparatus comprising a decoder and a display unit, the method comprising, causing the decoder to receive an instruction from a compiler which receives a source code and output a decoding result, and causing the display unit to receive debug information output from the compiler and the decoding result from the decoder and display at least a correspondence between each decoded instruction and a position in the source code.

### BRIEF DESCRIPTION OF THE DRAWINGS

FIG. 1 is a block diagram showing the arrangement of a debug support apparatus according to the first embodiment of the present invention;

FIG. 2 is a chart for explaining the operation of a decoder in the debug support apparatus;

FIG. 3 is a view for explaining a display example of the decoding result of the decoder;

FIG. 4 is a view for explaining another display example of the decoding result of the decoder;

FIG. 5 is a chart for explaining the operation of an iteration analyzer in the debug support apparatus;

FIG. 6 is a view for explaining a display example of the analysis result of the iteration analyzer;

FIG. 7 is a view for explaining another display example of the analysis result of the iteration analyzer;

FIG. 8 is a chart for explaining the display content and the information supplied to a display unit in the debug support apparatus;

FIG. 9 is a flowchart showing the processing sequence in a support method using the debug support apparatus;

FIG. 10 is a block diagram showing the arrangement of a debug support apparatus according to a comparative example;

FIG. 11 is a chart for explaining the operation of a decoder in the debug support apparatus according to the comparative example;

FIG. 12 is a chart for explaining the display content and the information supplied to a display unit in the debug support apparatus according to the comparative example;

FIG. 13 is a view for explaining a display example of the decoding result of the decoder in the debug support apparatus according to the comparative example;

FIG. 14 is a view for explaining another display example of the decoding result of the decoder in the debug support apparatus according to the comparative example; and

FIGS. 15-18 are block diagrams showing the arrangements of debug support apparatuses according to the second to fifth embodiments of the present invention.

### DETAILED DESCRIPTION OF THE INVENTION

As described above, VLIW is a technique for speeding up programs by simultaneously executing an instruction set made up of a plurality of independent instructions. Loop unrolling and software pipelining are available as techniques for greatly enhancing the VLIW effects.

A debug support method and apparatus according to an embodiment of the present invention can improve the debug efficiency of a source program compiled by a compiler employing the above techniques.

Debug support apparatuses according to embodiments of the present invention will be described with reference to the accompanying drawings.

### (1) First Embodiment

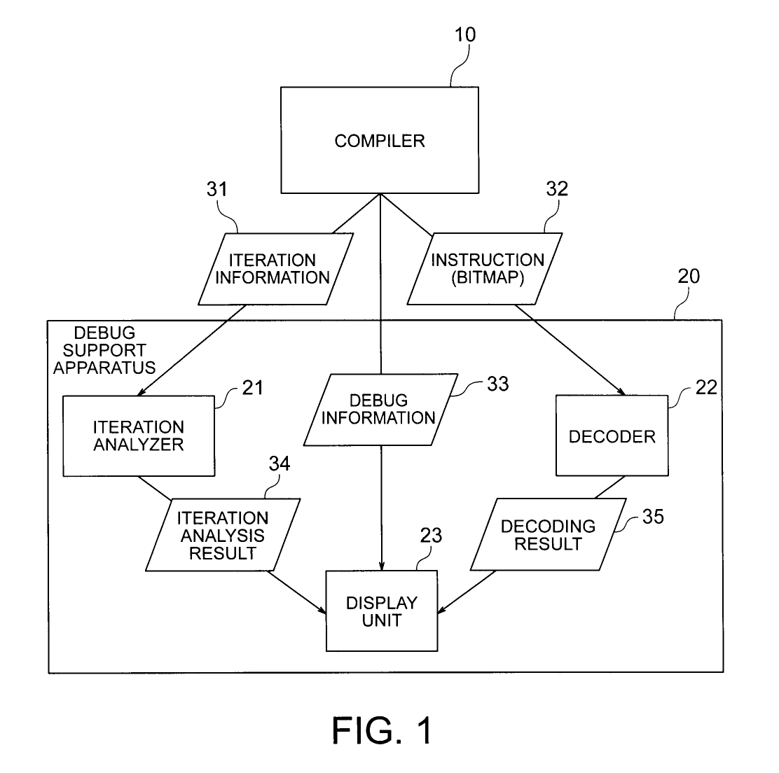

As described above, a debug support apparatus 20 according to the first embodiment comprises an iteration analyzer 21, decoder 22, and display unit 23, as shown in FIG. 1.

The iteration analyzer 21 receives iteration information 31 from a compiler 10 which receives a source code described in a high-level language. The iteration analyzer 21 performs iteration analysis and displays an analysis result 31 on the display unit 23.

The decoder 22 receives an instruction 32 in the form of a bitmap from the compiler 10, decodes it, and outputs a decoding result 35 to the display unit 23. The decoding result 35 includes an instruction as a machine instruction, and information representing which processor of a multiprocessor executes the instruction or information representing which slot of a processor having a plurality of slots is used to execute the instruction.

The display unit 23 displays debug information 33 output from the compiler 10 in addition to the iteration analysis result 34 and the decoding result 35.

The operation contents of the first embodiment with the above arrangement will be described in detail below.

### DISPLAY OF CORRESPONDENCE BETWEEN EACH INSTRUCTION AND SOURCE LINE

Assume that VLIW is applied to this embodiment. In this case, the compiler 10 receives a source code and automatically compiles a plurality of instructions into one instruction set to be executed in one step. Alternatively, the compiler 10 receives a source code as one instruction set into which a plurality of instructions are compiled. In this case, some instructions in the instruction set often correspond to different line numbers on the source code.

For example, assume that three instructions, add (addition), sub (subtraction), and mul (multiplication) are compiled into one instruction set and correspond to lines 10, 11, and 12, respectively.

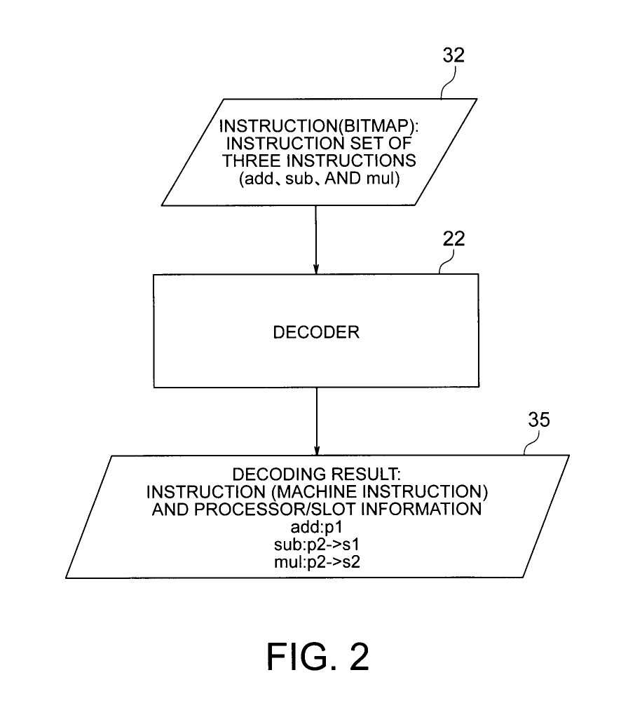

The compiler 10 receives a source code in which three instructions are compiled, and outputs a bitmap instruction 32 to the decoder 22, as shown in FIG. 2. The decoder 22 outputs a machine instruction as a decoding result 35. The decoding result 35 does not include information representing the correspondence between each instruction and the corresponding line number. However, the display unit 23 can display the correspondence between each decoded instruction and the line number on the source code by combining the decoding result 35 and the debug information 33 output from the compiler 10.

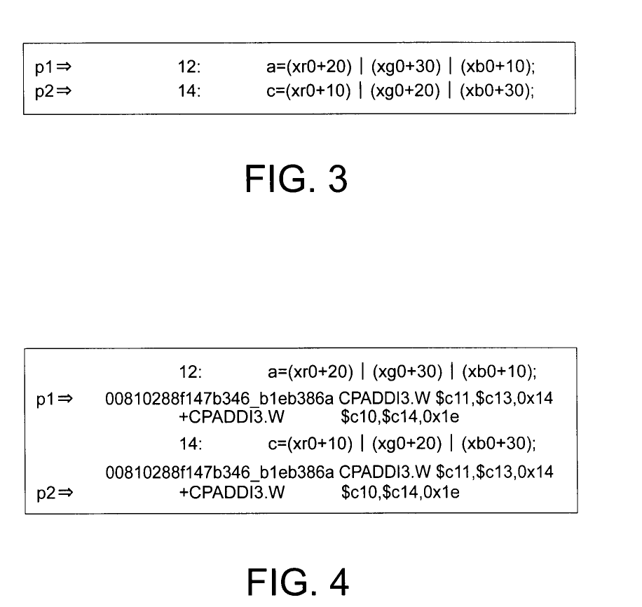

FIG. 3 shows an example of the contents displayed on the display unit 23. FIG. 3 shows only the source code but does not show an object code described in the machine language.

The display unit 23 displays the instruction “a=(xr+20)|xg0+30|(xb9+10);” on line 12 of the source code and the instruction “c=(xr0+10)|xg0+20|(xb0+30);” on line 14 of the source code.

As described above, the first embodiment can clarify the correspondence between each instruction to be executed and the corresponding source line.

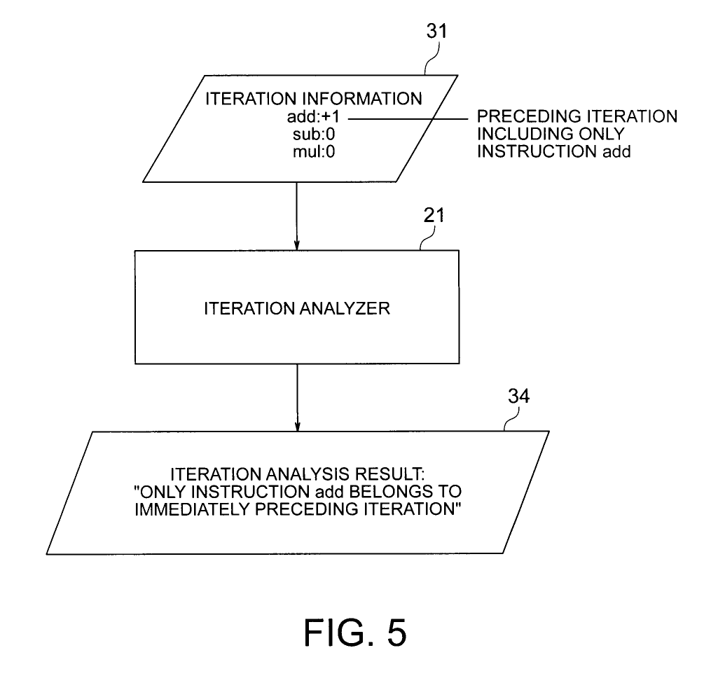

FIG. 4 shows another example of contents displayed on the display unit 23. FIG. 4 shows an object code described in the machine language in addition to the source code.

The display unit 23 displays the instruction “a=(xr0+20)|(xg0+30)|(xb0+10);” on line 12 of the source code and its decoded instruction described in the machine language as “CPADDI3.W $c11, $c13, 0x14, $c10, $c14, 0x1e”. Similarly, the display unit 23 displays the instruction “c=(xr0+10)|xg0+20|(xb0+30);” on line 14 of the source code and its decoded instruction described in the machine language as “CPADDI3.W $c11, $c13, 0x14, $c10, $c14, 0x1e”.

### Display of Correspondence Between Each Instruction and Processor or Slot Used

Generally, when VLIW is applied and a plurality of instructions are compiled as one instruction set and executed, a plurality of processors execute the instructions, respectively, or slots of one or two or more processors each having a plurality of slots are used to execute the instructions, respectively.

Assume that two processors proc1 and proc2 are present and that only proc2 has two instruction input slots slot1 and slot2.

When three instructions, add, sub, and mul are compiled into one instruction set and the instruction set is executed using these computation resources, one of the slots slot1 of the processors proc1 and proc2 and the slot slot2 of the processor proc2 is used to execute each instruction.

As shown in FIG. 2, the decoder 22 of the debug support apparatus according to the first embodiment analyzes which processor or which slot of one of the processors is used to execute each of the three instructions forming the instruction set. The decoder 22 outputs the analysis result including the decoding result 35. As shown in the decoding result 35, the “add (addition)” instruction, the “sub (subtraction)” instruction, and the “mul (multiplication)” instruction are executed in the slot s1 of the processor p1, the slot s1 of the processor p2, and the slot s2 of the processor p2, respectively.

FIG. 3 shows an example of the display contents of the display unit 23 which display the correspondence between each instruction and a processor or slot which is used to execute the instruction. As described above, only the source code is displayed. No object code described in the machine language is displayed.

The processor p2 executes the instruction “a=(xr0+20)|xg0+30|(xb0+10);” on line 12 of the source code, and the processor p2 executes the instruction “c=(xr0+10)|xg0+20|(xb0+30);” on line 14 of the source code.

FIG. 4 shows another example of the contents displayed on the display unit 23. The object code in the machine language is displayed in addition to the source code.

The display unit 23 displays the instruction “a=(xr0+20)|xg0+30|(xb0+10);” on line 12 of the source code and the decoded instruction “CPADDI3.W $c11, $c13, 0x14, $c10, $c14, 0xle” in the machine language. The processor p1 executes this instruction. The display unit 23 displays the instruction “c=(xr0+10)|xg0+20|(xb0+30);” on line 14 of the source code and the decoded instruction “CPADDI3.W $c11, $c13, 0x14, $c10, $c14, 0xle” in the machine language. The processor p2 executes this instruction.

As described above, the first embodiment can clarify the correspondence between each instruction to be executed and a processor or slot used to execute this instruction.

### Display of Correspondence Between Each Instruction and Iteration to Which Each Instruction Belongs

In general iteration processing such as a loop, after a given iteration (to be referred to as a preceding iteration hereinafter) is finished, the succeeding iteration (to be referred to as a succeeding iteration hereinafter) is started.

For example, to execute four instructions, add (addition), sub (subtraction), mul (multiplication), and div (division) one by one in a loop, these four instructions are executed in the first iteration, and then the second and subsequent iterations are started.

When loop unrolling or software pipelining is applied, however, the succeeding iteration can be started even if the preceding iteration is not finished yet.

More specifically, in the above example, even if the instructions add (addition), sub (subtraction), mul (multiplication), and div (division) belonging to the first iteration are not finished yet, the instruction add (addition) belonging to the second iteration can be executed.

When VLIW is used together with loop unrolling or software pipelining, instructions belonging to different iterations can be executed as an instruction set.

In the above example, the instructions sub (subtraction) and mul (multiplication) belonging to the preceding iteration can be joined together with the instruction add (addition) belonging to the succeeding iteration.

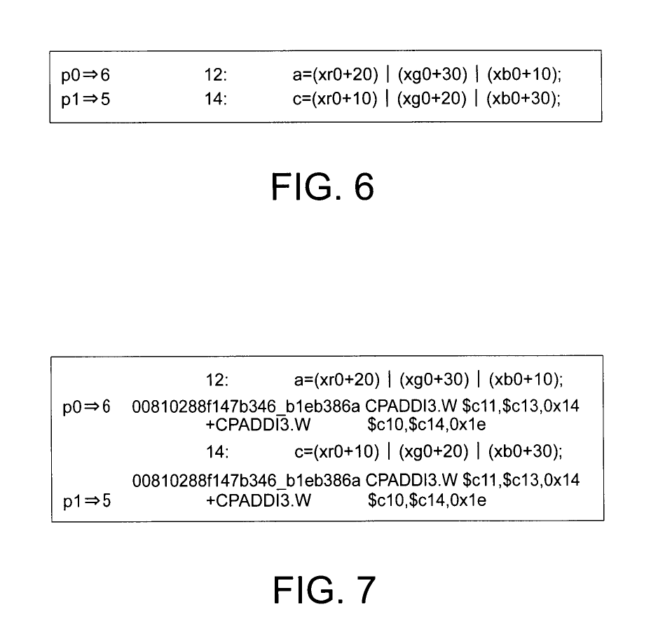

In this case, the iteration analyzer 21 of the debug support apparatus according to the first embodiment analyzes the respective instructions and iterations to which the instructions belong. As shown in FIG. 5, the iteration analyzer 21 receives the iteration information 31 from the compiler 10. This iteration information 31 indicates that only the instruction add (addition) of the instructions add (addition), sub (subtraction), and mul (multiplication) belongs to the immediately preceding iteration.

The iteration analyzer 21 analyzes this iteration information 31 and outputs the iteration analysis result 34 including information indicating that “only the instruction add (addition) belongs to the immediately preceding iteration”.

The display unit 23 displays the correspondence between the respective instructions in a source code or an object code in the machine language and iterations to which the instructions belong.

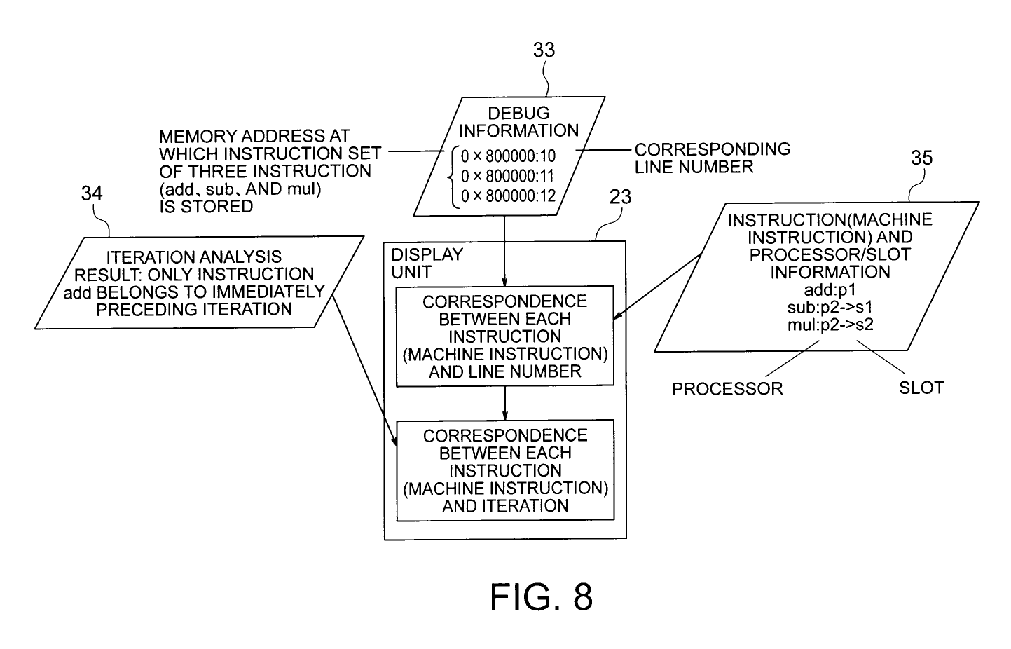

FIG. 6 shows an example of contents displayed on the display unit 23. The display unit 23 displays only the source code, but not the object code in the machine language.

The instruction “a=(xr0+20)|(xg0+30)|(xb9+10);” on line 12 of the source code belongs to the sixth iteration, and the instruction “c=(xr0+10)|(xg0+20)|(xb0+30);” on line 14 of the source code belongs to the fifth iteration.

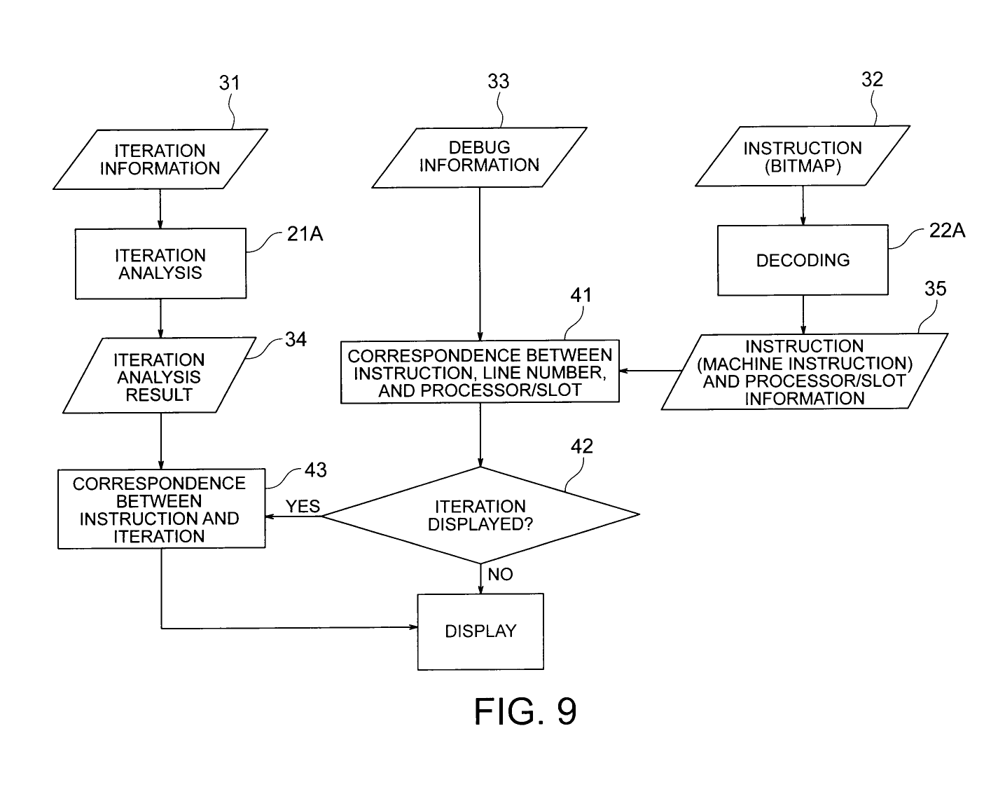

FIG. 7 shows another example of the contents displayed on the display unit 23. The display unit 23 displays the object code in the machine language in addition to the source code.

The display unit 23 displays “a=(xr0+20)|xg0+30|(xb9+10);” on line 12 of the source code and its decoded instruction “CPADDI3.W $c11, $c13, 0x14, $c10, $c14, 0x1e” in the machine language. This instruction belongs to the sixth iteration. The display unit 23 also displays the instruction “c=(xr0+10)|xg0+20|(xb0+30);” on line 14 of the source code and its decoded instruction “CPADDI3.W $c11, $c13, 0x14, $c14, 0x1e” in the machine language. This instruction belongs to the fifth iteration.

As described above, the first embodiment can clarify the relationship between the respective instructions to be executed and the iterations to which the instructions belong.

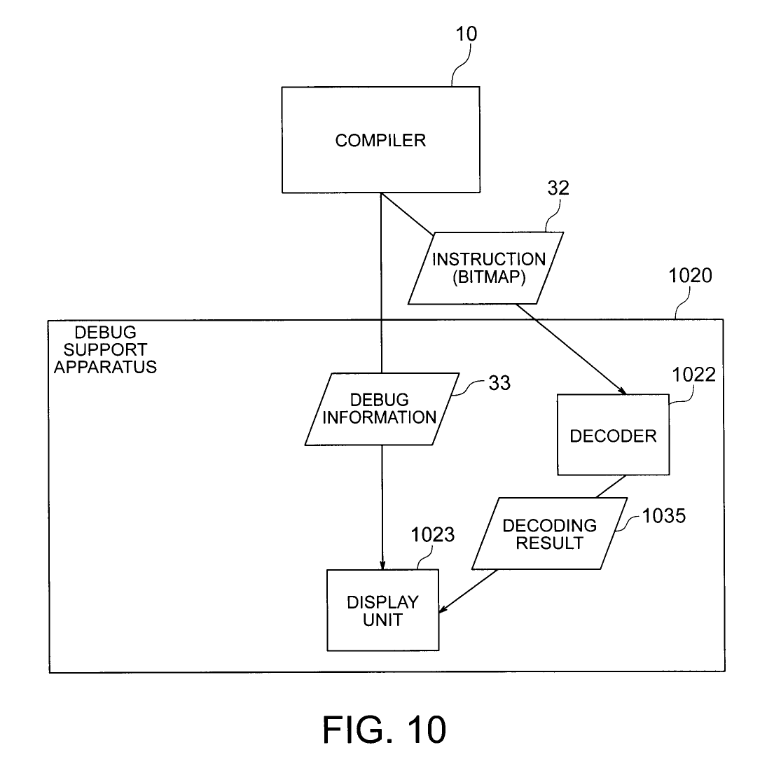

FIG. 8 shows that the display unit 23 displays the “correspondence between each instruction and source line”, the “correspondence between each instruction and a processor or slot which is used to execute the instruction”, and the “correspondence between each instruction and the iteration to which the instruction belongs”.

The display unit 23 receives the debug information 33 from the compiler 10, the decoding result 35 from the decoder 22, and iteration analysis result 34 from the iteration analyzer 21.

The debug information 33 contains a memory address at which three instructions (add, sub, and mul) as an instruction set to be simultaneously executed are stored. For example, the instructions add (addition), sub (subtraction), and mul (multiplication) as an instruction set are stored together at an address “0x800000”. The instructions add (addition), sub (subtraction), and mul (multiplication) are present on lines 10, 11, and 12, respectively, of the source code.

The decoding result 35 includes the respective instructions in the machine language and information representing the processors or slots used to execute these instructions.

The iteration analysis result 34 indicates the relationship between the respective instructions and the iterations to which the instructions belong.

The display unit 23 displays all these pieces of information. That is, the display unit 23 displays correspondence between each instruction and source line, the correspondence between each instruction and a processor or slot which is used to execute the instruction, and the correspondence between each instruction and the iteration to which the instruction belongs.

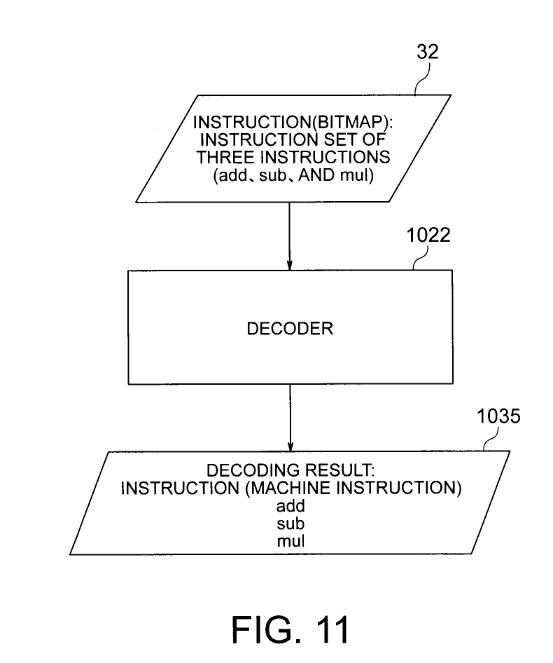

The processing sequence in the debug support method using the debug support apparatus according to the first embodiment is shown in the flowchart in FIG. 9. The iteration display is selectable.

The decoder 22 receives the instruction 32 in the form of a bitmap from the compiler 10, decodes it in step 22A, and outputs as the decoding result 35 information indicating the relationship between the instructions in the machine language and processors or slots which are used execute the instructions.

The iteration analyzer 21 receives the iteration information 21A output from the compiler 10, analyzes it in step 21A, and outputs the iteration analysis result 34.

The compiler 10 outputs the debug information 33. In step 41, the display unit 23 displays information representing the correspondence between the respective instructions and the line numbers in the source code or information representing the correspondence between the instructions and the processors or slots which are used to execute the instructions in accordance with the combinations of the decoding result 35 and the debug information 33.

Upon receiving the iteration analysis result 34, the display unit 23 determines in step 42 whether iteration display is performed. If a function of no display of the iteration is selected, the display unit 23 performs no display regarding only the iteration. However, if a function of performing the display is selected, the display unit 23 displays in the step 43 the correspondence between the respective instructions and the iterations to which the instructions belong.

### COMPARATIVE EXAMPLE

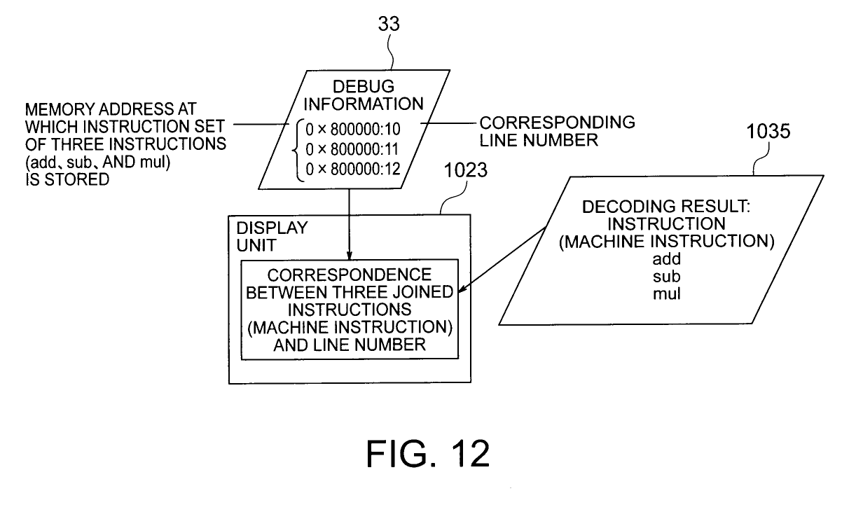

FIG. 10 shows the arrangement of a debug support apparatus as a comparative example. This debug support apparatus comprises a decoder 1022 and a display unit 1023.

The decoder 1022 receives an instruction 32 in the form of a bitmap from the compiler 10, and generates and outputs a decoding result 1035 having instructions in the machine language.

The display unit 1023 receives and displays the debug information 33 output from the compiler 10 and the decoding result 1035.

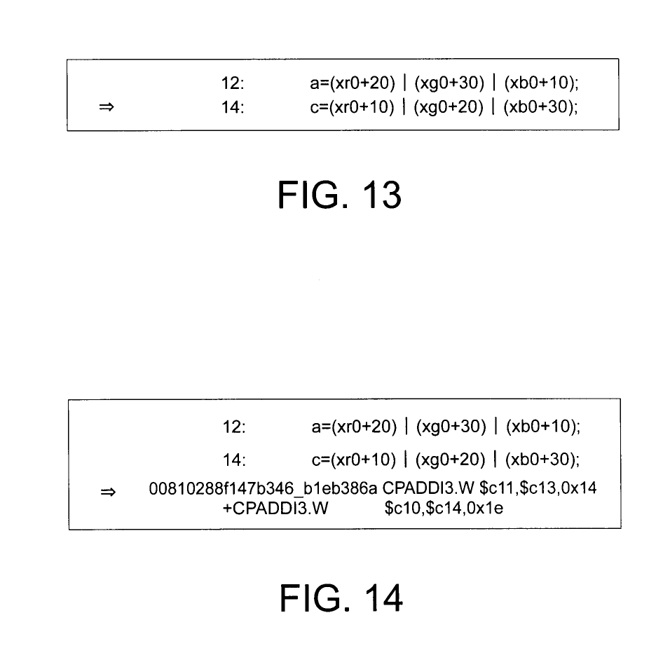

The decoder 1022 receives, for example, three instructions (add (addition), sub (subtraction), and mul (multiplication) as an instruction set, as shown in FIG. 11. The decoder 1022 decodes these instructions and outputs a decoding result 1035.

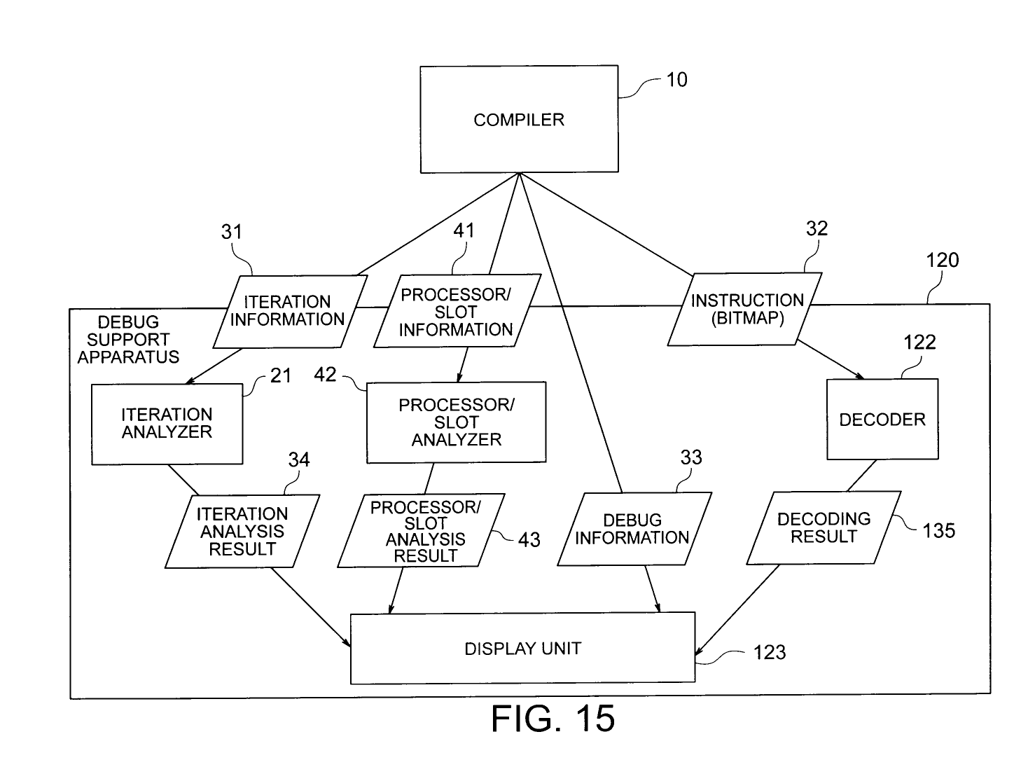

As a result, as shown in FIG. 12, the display unit 1023 receives the debug information 33 and the decoding result 1035 and displays the correspondence between the decoded result including the three instructions as an instruction set and the line numbers of the source code.

The debug information 33 includes a memory address at which the three instructions (add, sub, and mul) as the instruction unit are stored. For example, the instructions add (addition), sub (subtraction), and mul (multiplication) as an instruction set are stored together at an address “0x800000”. The instructions add (addition), sub (subtraction), and mul (multiplication) are present on lines 10, 11, and 12, respectively, of the source code.

The decoding result 35 includes the respective instructions in the machine language but does not include information representing the processors or slots which are used to execute these instructions unlike in the first embodiment.

No iteration information is supplied, so the relationship between the respective instructions and iterations to which the instructions belong is not clarified.

The display unit 23 displays the correspondence between the instruction set in the machine language and the line numbers of the source code, but does not display the relationship between the respective instructions and the processors or slots which are used to execute the instructions and the correspondence between the respective instructions and the iterations to which the instructions belong.

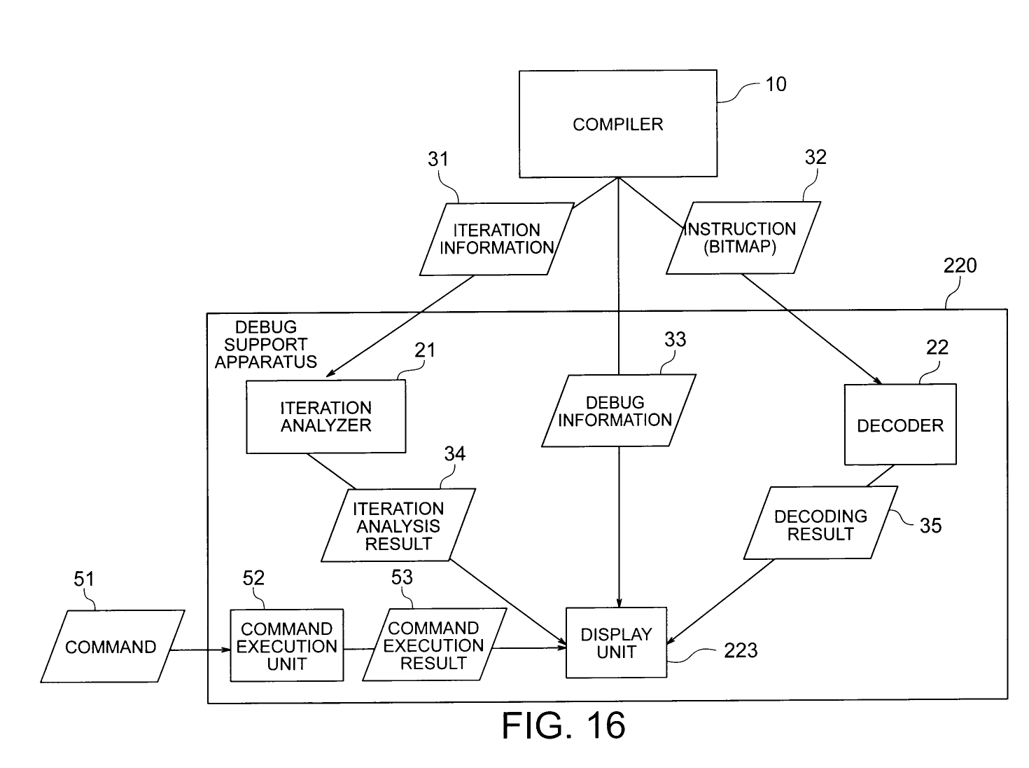

FIG. 13 shows an example of displaying only a source code.

In this case, the two instructions on lines 12 and 14 of the source code are joined and executed together. When these two instructions are joined, one pointer “→” is added.

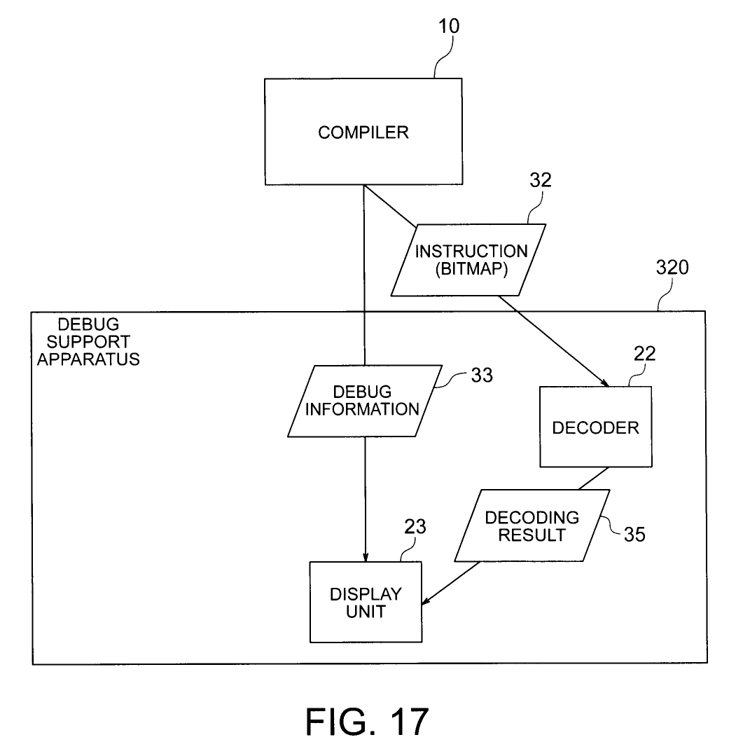

FIG. 14 shows another display example when a source code and instructions in the machine language are displayed.

The two instructions on lines 12 and 14 of the source code are joined, and the instruction set is displayed as one instruction in the machine language. A pointer “→” is added to one decoded machine language obtained by joining the two instructions on the source code.

The instructions “CPADDI3.W $c11, $c13, 0x14” and “CPADDI3.W $c10, $c14, 0x1e” in the machine language correspond to lines 12 and 14, respectively, on the source code.

However, the display unit displays the instructions as if both the instructions “CPADDI3.W $c11, $c13, 0x14” and “CPADDI3.W $c10, $c14, 0x1e” corresponded to line 14 on the source code.

The display unit does not display information representing the processor or slot which is used to execute each instruction, and information representing the iteration to which each instruction belongs. For this reason, debug efficiency inevitably degrades.

The comparative example suffers the following problems.

a) The display unit cannot display the correspondence between the respective instructions in the instruction set and the line numbers on the source code. For this reason, an accurate correspondence between the respective instructions in the instruction set and the line numbers on the source code is unclear.

b) The display unit displays no information on the processors or slots which are used to execute the respective instructions in the instruction set.

c) Since the iteration information cannot be analyzed, the display unit cannot display the correspondence between the respective instructions and the iterations to which the instructions belong.

The above problems degrades the debug efficiency in the debug support apparatus of the comparative example.

### (2) Second Embodiment

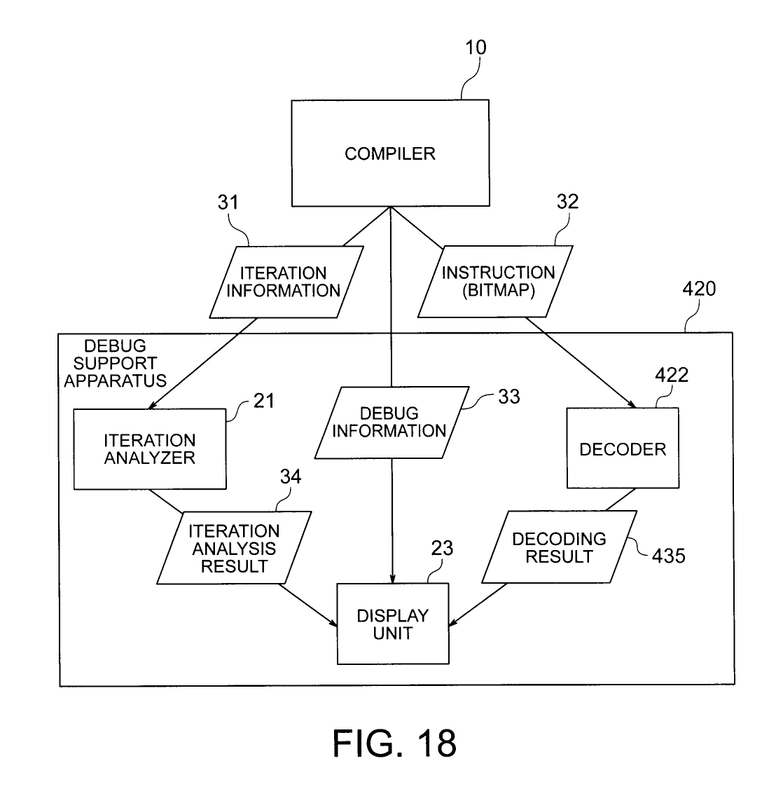

FIG. 15 shows the arrangement of a debug support apparatus according to the second embodiment of the present invention.

Unlike the debug support apparatus 20 of the first embodiment, in a debug support apparatus 120 of the second embodiment, a decoding result 135 output from a decoder 122 includes an instruction in the machine language but does not include the correspondence between the respective instructions and the processors or slots which are used to execute the instructions.

Instead, the debug support apparatus 120 comprises a processor/slot analyzer 42. The processor/slot analyzer 42 receives processor/slot information 41 from a compiler 10 and outputs a processor/slot analysis result 43, which is then supplied to a display unit 123.

As can be apparent from the above description, when the compiler 10 can generate the processor/slot information 41, the processor/slot analyzer 42 analyzes this information 41 which can be displayed on the display unit 123.

The debug support apparatus 120 must comprise the processor/slot analyzer 42, but the decoder 122 neither need generate the processor/slot information nor output the decoding result 135 containing the processor/slot information.

The second embodiment can clarify the correspondence between each instruction and a processor or slot which is used to execute this instruction in the same manner as in the first embodiment. The same reference numerals as in the first embodiment denote the same parts in the second embodiment, and a detailed description thereof will not be repeated.

### (3) Third Embodiment

A debug support apparatus according to the third embodiment of the present invention will be described with reference to FIG. 16 showing its arrangement.

A debug support apparatus 220 according to the third embodiment is different from that of the first embodiment in that the apparatus further comprises a command execution unit 52 which receives and executes a command 51 and outputs a command execution result. A display unit 223 receives a command execution result 53 in addition to an iteration analysis result 34 and decoding result 35 and displays them. The same reference numerals as in the first embodiment denote the same parts in the third embodiment, and a detailed description thereof will not be repeated.

According to the third embodiment, an operator using debug support apparatus inputs the command 51 and makes the display unit 223 display the following contents.

Assume that the operator inputs the following two commands 51 to the debug support apparatus 220.

1) Commands “break” for stopping the operation of the debug support apparatus 220 are supplied at lines 12 and 14, respectively, of the source code.

2) Commands “go” are supplied to execute operations until lines 12 and 14 on which the commands “break” have been set.

The command execution unit 52 receives these two types of commands and then executes them. The codes until lines 12 and 14 are executed, and the operations stop at lines 12 and 14.

The command execution unit 52 supplies as the command execution result 53 information representing that the operations currently stop at lines 12 and 14 of the source code to the display unit 223. On the basis of this information, the display unit 223 displays that the operations currently stop at lines 12 and 14 of the source code.

This command execution unit can be added to the first and second embodiment.

According to the first to third embodiments, upon decoding, the display unit can display which line on the source code corresponds to each instruction and which processor or slot is used to execute each instruction. In addition, the display unit displays which iteration includes each instruction.

When a bug is found in one instruction, e.g., “add”, the line on which this instruction is present can be clarified. Only the line on which the bug is present can be debugged, thereby improving the efficiency.

The debug support apparatus according to each embodiment can improve the debug efficiency, thereby achieving program development using this debug support apparatus within a short period of time.

The above embodiments are merely examples, and the present invention is not limited to them. Various changes and modifications can be made within the technical scope of the present invention.

For example, a debug support apparatus according to the fourth embodiment of the present invention shown in FIG. 17 is different from that of the first embodiment in that the iteration analyzer 21 is not included. In the fourth embodiment, the display unit can display the correspondence between each instruction and each line on the source code, which is output as a decoding result 35 from a decoder 22. The decoding result 35 need not necessarily include information representing the correspondence between the respective instructions and the processors or slots which are used to execute them.

Unlike in the first embodiment, in a debug support apparatus 420 according to the fifth embodiment of the present invention shown in FIG. 18, a decoding result 435 output from a decoder 22 includes instructions expressed in the machine language, but does not include information representing the correspondence between each instruction and the processor or slot which is used to execute it. According to the fifth embodiment, a display unit 23 displays the correspondence between the respective instructions and the iterations to which the instructions belong.

The debug support apparatus according to each embodiment described above can improve the debug efficiency.

What is claimed is:

1. A debug support apparatus comprising:
a decoder configured to receive an instruction output from a compiler which receives a source code, decode the instruction, and output a decoding result; and
a display unit configured to receive debug information output from the compiler and the decoding result output from the decoder and display at least a correspondence between each decoded instruction and a position in the source code.

2. The apparatus according to claim 1,
further comprising an iteration analyzer configured to analyze iteration information output from the compiler and output an iteration analysis result representing a correspondence between the each decoded instruction and an iteration to which the each decoded instruction belongs,
wherein the display unit receives the debug information output from the compiler, the decoding result output from the decoder, and the iteration analysis result output from the iteration analyzer and displays at least a correspondence between the each decoded instruction and the position in the source code and a correspondence between the each decoded instruction and an iteration to which the each decoded instruction belongs.

3. The apparatus according to claim 1, wherein
the decoder outputs the decoding result including one of information representing which processor executes the each decoded instruction and information representing which slot of a processor is used to execute the each decoded instruction, and
the display unit displays the correspondence between the each decoded instruction and one of the processor and slot which is used to execute the each decoded instruction.

4. The apparatus according to claim 2, wherein
the decoder outputs the decoding result including one of information representing which processor executes the each decoded instruction and information representing which slot of a processor is used to execute the each decoded instruction, and
the display unit displays the correspondence between the each decoded instruction and one of the processor and slot which is used to execute the each decoded instruction.

5. The apparatus according to claim 1,
further comprising:
an iteration analyzer configured to analyze iteration information output from the compiler and output an iteration analysis result representing a correspondence between the each decoded instruction and an iteration to which the each decoded instruction belongs; and
a processor/slot analyzer configured to receive, from the compiler, one of information representing which processor is used to execute each instruction and information representing which one of slots of each of processors is used to execute each instruction, analyze the received information, and output a processor/slot analysis result representing one of information representing which processor is used to execute each decoded instruction and information representing which one of slots of each of processors is used to execute the each decoded instruction,
wherein the display unit receives the debug information output from the compiler, the decoding result output from the decoder, the iteration analysis result output from the iteration analyzer, and the processor/slot analysis result, and display at least a correspondence between the each decoded instruction and a position in the source code, a correspondence between the each decoded instruction and an iteration to which the each decoded instruction belongs, and a correspondence between the each decoded instruction and one of a processor and slot which is used to execute the each decoded instruction.

6. The apparatus according to claim 2,
further comprising a processor/slot analyzer configured to receive, from the compiler, one of information representing which processor is used to execute each instruction and information representing which one of slots of each of processors is used to execute each instruction, analyze the received information, and output a processor/slot analysis result representing one of information representing which processor is used to execute each decoded instruction and information representing which one of slots of each of processors is used to execute the each decoded instruction,
wherein the display unit receives the debug information output from the compiler, the decoding result output from the decoder, the iteration analysis result output from the iteration analyzer, and the processor/slot analysis result, and display at least a correspondence between the each decoded instruction and a position in the source code, a correspondence between the each decoded instruction and an iteration to which the each decoded instruction belongs, and a correspondence between the each decoded instruction and one of a processor and slot which is used to execute the each decoded instruction.

7. The apparatus according to claim 1,
further comprising a command execution unit configured to receive and execute a command and output a command execution result,
wherein the display unit further displays the command execution result.

8. The apparatus according to claim 2,
further comprising a command execution unit configured to receive and execute a command and output a command execution result,
wherein the display unit further displays the command execution result.

9. The apparatus according to claim 3,
further comprising a command execution unit configured to receive and execute a command and output a command execution result,
wherein the display unit further displays the command execution result.

10. The apparatus according to claim 4,
further comprising a command execution unit configured to receive and execute a command and output a command execution result,
wherein the display unit further displays the command execution result.

11. The apparatus according to claim 5,
further comprising a command execution unit configured to receive and execute a command and output a command execution result,
wherein the display unit further displays the command execution result.

12. The apparatus according to claim 6,
further comprising a command execution unit configured to receive and execute a command and output a command execution result,
wherein the display unit further displays the command execution result.

13. A method of performing debug support using a debug support apparatus comprising a decoder and a display unit, the method comprising:
causing the decoder to receive an instruction from a compiler which receives a source code and output a decoding result; and
causing the display unit to receive debug information output from the compiler and the decoding result from the decoder and display at least a correspondence between each decoded instruction and a position in the source code.

14. The method according to claim 13,
wherein the debug support apparatus further comprises an iteration analyzer, the method comprises:
causing the iteration analyzer to analyze iteration information output from the compiler and output an iteration analysis result representing a correspondence between the each decoded instruction and an iteration to which the each decoded instruction belongs,
causing the display unit to receive the debug information output from the compiler, the decoding result output from the decoder, and the iteration analysis result output from the iteration analyzer and display at least a correspondence between the each decoded instruction and the position in the source code and a correspondence between the each decoded instruction and an iteration to which the each decoded instruction belongs.

15. The method according to claim 13, wherein the method comprises:
causing the decoder to output the decoding result including one of information representing which processor executes the each decoded instruction and information representing which slot of a processor is used to execute the each decoded instruction, and
causing the display unit to display the correspondence between the each decoded instruction and one of the processor and slot which is used to execute the each decoded instruction.

16. The method according to claim 14, wherein the method comprises:
causing the decoder to output the decoding result including one of information representing which processor executes the each decoded instruction and information representing which slot of a processor is used to execute the each decoded instruction, and
causing the display unit to display the correspondence between the each decoded instruction and one of the processor and slot which is used to execute the each decoded instruction.

17. The method according to claim 13,
wherein the debug support device further comprises an iteration analyzer and a processor/slot analyzer, and the method comprises:
causing the iteration analyzer to analyze iteration information output from the compiler and output an iteration analysis result representing a correspondence between the each decoded instruction and an iteration to which the each decoded instruction belongs;
causing the processor/slot analyzer to receive, from the compiler, one of information representing which processor is used to execute each instruction and information representing which one of slots of each of processors is used to execute each instruction, analyze the received information, and output a processor/slot analysis result representing one of information representing which processor is used to execute each decoded instruction and information representing which one of slots of each of processors is used to execute the each decoded instruction; and
causing the display unit to receive the debug information output from the compiler, the decoding result output from the decoder, the iteration analysis result output from the iteration analyzer, and the processor/slot analysis result, and display at least a correspondence between the each decoded instruction and a position in the source code, a correspondence between the each decoded instruction and an iteration to which the each decoded instruction belongs, and a correspondence between the each decoded instruction and one of a processor and slot which is used to execute the each decoded instruction.

18. The method according to claim 14, wherein the debug support apparatus further comprises a processor/slot analyzer, and the method comprises:
causing the processor/slot analyzer to receive, from the compiler, one of information representing which processor is used to execute each instruction and information representing which one of slots of each of processors is used to execute each instruction, analyze the received information, and output a processor/slot analysis result representing one of information representing which processor is used to execute each decoded instruction and information representing which one of slots of each of processors is used to execute the each decoded instruction; and
causing the display unit to receive the debug information output from the compiler, the decoding result output from the decoder, the iteration analysis result output from the iteration analyzer, and the processor/slot analysis result, and display at least a correspondence between the each decoded instruction and a position in the source code, a correspondence between the each decoded instruction and an iteration to which the each decoded instruction belongs, and a correspondence between the each decoded instruction and one of a processor and slot which is used to execute the each decoded instruction.

19. The method according to claim 13, wherein the debug support apparatus further comprises a command execution unit, and the method further comprises:
causing the command execution unit to receive and execute a command and output a command execution result; and
causing the display unit to display the command execution result.
